(19) United States
(12) Patent Application Publication
(10) Pub. No.: US 2026/0209427 A1
(43) Pub. Date: Jul. 23, 2026

(54) NEW ETHER-AMINE COMPOSITIONS AND THE USE THEREOF AS CURING AGENTS FOR EPOXY RESINS

(71) Applicant: BASF SE, Ludwigshafen am Rhein (DE)

(72) Inventors: Matthaeus Kopczynski, Ludwigshafen am Rhein (DE); Hannes Ferdinand Gouverneur, Ludwigshafen am Rhein (DE); Sirus Zarbakhsh (Deceased), Ludwigshafen am Rhein (DE)

(73) Assignee: BASF SE, Ludwigshafen am Rhein (DE)

(21) Appl. No.: 19/137,537

(22) PCT Filed: Dec. 4, 2023
(86) PCT No.: PCT/EP2023/084101

§ 371 Date: Jun. 10, 2025

(30) Foreign Application Priority Data
Dec. 13, 2022 (EP) 22213093.2

(51) Int. Cl. C08G 59/50; B01J 23/755; C08G 59/24; C08G 65/26; C08G 65/30; C08G 65/325

(52) U.S. Cl. CPC C08G 59/504; B01J 23/755; C08G 59/245; C08G 65/2609; C08G 65/2687; C08G 65/30; C08G 65/3255

(57) ABSTRACT

Compositions of ether-amines have a high proportion of terminal alkylamine units having the formula —CH(CH₃)—CH₂—NH₂. A process prepares such compositions of ether-amines and curable compositions having epoxy resin and such compositions of ether-amines as curing agent. A process cures this curable composition and the resulting cured epoxy resin. These compositions of ether-amines are characterized by a comparably high reactivity even at low temperatures combined with a good early-stage water resistance and enables cured epoxy resins with good mechanical and thermal properties. These compositions are thus especially suitable for industrial coatings such as marine coating or flooring.

The present invention relates to compositions of ether-amines having a high proportion of terminal alkylamine units having the formula —CH(CH₃)—CH₂—NH₂, to the preparation of such compositions of ether-amines and to curable compositions comprising epoxy resin and such compositions of ether-amines as curing agent. The invention further relates to the curing of this curable composition and the resulting cured epoxy resin.

Epoxy resins are common knowledge and on account of their toughness, flexibility, adhesion, and chemicals resistance are used as materials for surface coating, as adhesives and for moulding and laminating as well as for producing fibre-reinforced composite materials.

Typical curing agents for epoxy resins are polyamines which bring about a polyaddition reaction (chain extension). Polyamines having a high reactivity are generally added only shortly before the desired curing. Such systems are therefore so-called two-component (2K) systems.

An important application of epoxy resins is surface coating and in particular floor coating (flooring). This application requires curing agents which allow rapid curing even at low temperatures. The coating shall be loadable as soon as possible after application to the surface (walkability of floor coatings), i.e., have a sufficient hardness (for example Shore D hardness). A high glass transition temperature of the coating so that the coating remains stable at high usage temperatures is also an important criterion. For a coating of surfaces exposed to moisture (for example outdoor floor coatings) good early-stage water resistance is important too.

Polyetheramines such as Jeffamine® D230 or Jeffamine® D400 are commonly known curing agents for epoxy resins in various applications such as coating, flooring, adhesive and electrical potting applications (Ullmann's Encyclopedia of Industrial Chemistry, Wiley-VCH, Weinheim, Germany, 2012, Vol. 13, Epoxy Resins, H. Pham & M. Marks (online: 15.10.2005, DOI: 10.1002/14356007.a09_547.pub2)). The propylene oxide based polyetheramines such as Jeffamine® D230 or Jeffamine® D400 exhibit low viscosity and vapor pressure and they allow for low temperature curing of epoxy resins. They provide tough, clear and impact resistant cured epoxy resins which makes them particularly suitable for coating, casting, and adhesive applications. They also exhibit a low tendency to surface blush (water-initiated carbamate formation) which is also favourable for coating applications such as flooring (Burton et. al., “Epoxy Formulations using Jeffamine® Polyetheramines”; technical brochure, publ. 27.04.2005).

A downside of these commonly known propylene oxide based polyetheramines is their low reactivity which results in slow cure rates, in particular for low temperature curing. To overcome this problem, these polyetheramines are typically combined with accelerators (e.g., phenolic compounds or tertiary amines) or other more reactive primary amines acting as co-curing agent. However, such additional components usually have a negative impact on the mechanical properties of the cured epoxy resin and many of those additional compounds are hazardous volatile organic compounds which make the handling problematic. On the other hand, known polyetheramines without alkyl sidechains, such as 4,9-Dioxadodecane-1,12-diamine (DODA) and 4,7,10-Trioxatridecane-1,13-diamine (TTD), exhibit a higher reactivity and allow a faster epoxy resin curing, but their production is expensive, and they are comparably hygroscopic which is disadvantageous in the context of coating applications.

There is a need for an amine curing agent for curing epoxy resins in particular for coating applications such as flooring, and also for adhesives, which combines the advantages of the known propylene oxide based polyetheramines with high reactivity and fast cure rates even without the addition of accelerators or other amines. Apart from the higher reactivity, such new amine curing agents should have the very similar profile of properties so that they can be used as a direct replacement of these known propylene oxide based polyetheramines within the established applications.

The present invention may accordingly be considered to have for its object to provide such an amine curing agent suitable for curing epoxy resins especially for coating applications such as flooring, industry coating or marine coating, and also for adhesives, which combines the advantages of known propylene oxide based polyetheramines such as Jeffamine® D230 or Jeffamine® D400 with higher reactivity and cure rates, particularly for the curing at low temperatures. Such higher reactivity is particularly advantageous for the use in combination with other highly reactive amine curing agents such as isophoronediamine.

The present invention accordingly relates to the provision of a hardener composition comprising an ether-amine composition consisting of one or more ether-amines of formula I

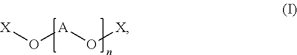

wherein A is —CH(CH₃)—CH₂— or —CH₂—CH(CH₃)—, and
each X is independently —CH(CH₃)—CH₂—NH₂ or —CH₂—CH(CH₃)—NH₂, and
n≥0,
characterized in that at least 30 mol-% of all X within the ether-amine composition are —CH(CH₃)—CH₂—NH₂.

The commonly known propylene oxide based polyetheramines such as Jeffamine® D230 or Jeffamine® D400 are represented by the formula I-a

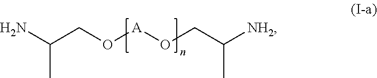

wherein A is —CH(CH₃)—CH₂— or —CH₂—CH(CH₃)—, and with n≥0.

Essentially all the aminated terminal propylene oxide units of these polyetheramines are —CH₂—CH(CH₃)—NH₂ groups with the methyl side chain directly vicinal to the amino group.

In contrast, the ether-amine composition of the invention is a mixture of the ether-amines of

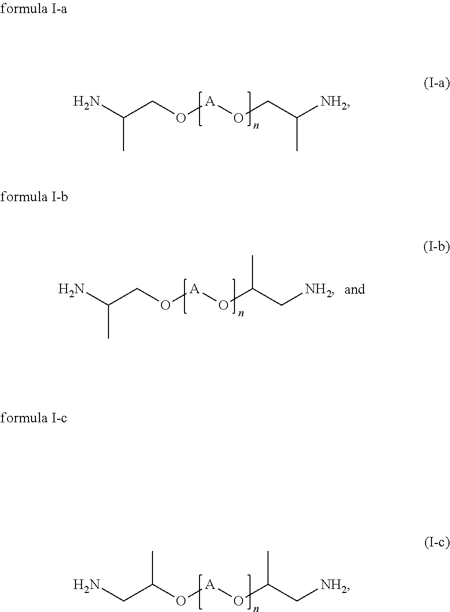

wherein A is —CH(CH₃)—CH₂— or —CH₂—CH(CH₃)—, and with n≥0,
with the provision that at least 30 mol-% of all aminated terminal propylene oxide units (—CH(CH₃)—CH₂—NH₂ groups or —CH₂—CH(CH₃)—NH₂ groups) of the ether-amines in this mixture are —CH(CH₃)—CH₂—NH₂ groups. Compared to the known propylene oxide based polyetheramines such as Jeffamine® D230 or Jeffamine® D400, these aminated terminal propylene oxide units have an inverse orientation so that the methyl side chain is not connected to the carbon vicinal to the amino group. For this reason, the ether-amine compositions of the invention are also referred to herein as “inverse polyetheramines”.

In a particular embodiment of the invention such mixture (the ether-amine composition) comprises only the ether-amines of formula I-b and/or I-c.

Preferably, the ether-amine composition of the invention is characterized in that at least 40 mol-%, more preferably at least 50 mol-%, and particularly preferably at least 60 mol-% of all aminated terminal propylene oxide units X within the ether-amine composition are —CH(CH₃)—CH₂—NH₂. The proportion of the two different terminal alkyl amine units, —CH(CH₃)—CH₂—NH₂ and —CH₂—CH(CH₃)—NH₂, can be determined e.g., by the means of ¹H-NMR or ¹³C-NMR Attached-Proton-Test (APT).

The ether-amines of the ether-amine composition are characterized by a value of n 0, e.g., in the range from 0 to 1000. Preferably, the ether-amines of the ether-amine composition are characterized by a value of n≥1, e.g., in the range from 1 to 100, more preferably from 1 to 20. The ether-amine composition of the invention is usually a mixture of ether-amines having different n. In this case, the value n̅ is the number-average over the n of all ether-amines of the above formula I. E.g., a mixture (ether-amine composition) of 50 mol-% of the ether-amine of formula I-c with n=1 and 50 mol-% of the ether-amine of formula I-c with n=2, has a number-average of n̅=1.5. The value n corresponds to the molecular weight M of the respective ether-amine (M_{EA}) according to the formula

M_{EA}=(132+n*58) g/mol.

The value n̅ corresponds to the average molecular weight M̅ of the respective ether-amine composition (M_{EA}) according to the formula

M̅_{EA}=(132+n*58) g/mol.

The value n̅ of the ether-amine composition is preferably in the range from 1 to 40, more preferably in the range from 1 to 10. The average molecular weight of the ether-amine composition (M̅_{EA}) is preferably in the range from 190 to 2450 g/mol, more preferably in the range from 190 to 700 g/mol.

The present invention further relates to a process for producing the hardener composition which comprises the ether-amine composition of the invention, comprising
(I) a step in which a corresponding polypropylene glycol composition (having the same formula as the ether-amines of the ether-amin composition but with hydroxy groups instead of amino groups) is prepared by ring-opening polymerization of propylene oxide using water, propylene glycol or dipropylene glycol as initiator and using an aprotic Lewis acid as catalyst, and
(II) a step in which the polypropylene glycol composition of the step (I) is converted into the corresponding ether-amine composition of the invention by catalytic reductive amination with hydrogen and ammonia.

The polypropylene glycol composition of the step (I) corresponds to the ether-amine composition of the invention but with hydroxy groups instead of amino groups. Accordingly, the polypropylene glycols of such composition are characterized by a comparably high proportion of primary hydroxy groups, preferably at least 30 mol-%, more preferably at least 40 mol-%, particularly preferably at least 50 mol-%, particularly at least 60 mol-% of all hydroxy groups within the polypropylene glycol composition are primary hydroxy groups. Such polypropylene glycols can be produced by ring-opening polymerization of propylene oxide catalysed by an aprotic Lewis acid (U.S. Pat. No. 6,531,566, WO2019/055725, Miyajima et al, Polymer J. (2015), 47, 771-778).

Preferred aprotic Lewis acid catalysts for step (I) of the process for producing the ether-amine composition are trifluoroborane, trifluoroaluminum, tris-organyl borane compounds, tris-organyl aluminium compounds, bis-organyl fluoroborane compounds, bis-organyl fluoroaluminum compounds, organyl difluoroborane compounds and organyl difluoroaluminum compounds. The organyl groups may be alkyl groups, aryl groups, arylalkyl groups or alkylaryl groups. The organyl groups of such compounds may be identical or different. The organyl groups may bear substituents as long as they are aprotic, e.g., fluor substituents. Preferably each organyl group has 1 to 20 carbon atoms, more preferably 3 to 10 carbon atoms. The alkyl groups may be linear, branched or cycloaliphatic. Preferably they are saturated. Preferred organyl groups are butyl groups such as n-butyl, i-butyl or preferably t-butyl and phenyl groups. Such butyl and phenyl groups may be unsubstituted or substituted, preferably with fluor atoms, e.g., pentafluorophenyl groups. Preferably the aprotic Lewis acid catalysts for step (I) of the process for producing the ether-amine composition are selected from a group of compounds consisting of triphenylborane, diphenyl-t-butylborane, tri(t-butyl)borane, triphenylaluminum, diphenyl-t-butylaluminum, tri(t-butyl)aluminum, tris(pentafluorophenyl)borane, bis(pentafluorophenyl)-t-butylborane, tris(pentafluorophenyl)aluminum, bis(pentafluorophenyl)-t-butylaluminum, bis(pentafluorophenyl)fluoroborane, di(t-butyl)fluoroborane, (pentafluorophenyl)difluoroborane, (t-butyl)difluoroborane, bis(pentafluoro-phenyl)fluoroaluminum, di(t-butyl)fluoroaluminum, (pentafluorophenyl)difluoroaluminum, and (t-butyl)difluoroaluminum. Particular preferably those catalysts are selected from a group of compounds consisting of triphenylborane, triphenylaluminum, tris(pentafluorophenyl)borane and tris(pentafluorophenyl)aluminum and more preferably those catalysts are tris(pentafluorophenyl)borane or tris(pentafluorophenyl)aluminum or mixtures thereof. Those catalysts can be a single aprotic Lewis acid compound or mixtures of two or more such compounds.

The step (I) of the process for producing the ether-amine composition is preferably carried out at a temperature in the range from 50 to 150° C. and at a pressure in the range from 1 to 50 bar.

The step (II) of the process for producing the ether-amine composition is preferably carried out with a comparably high excess of ammonia. Preferably the molar ratio of ammonia to the hydroxy groups of the polypropylene glycol composition is in the range from 5:1 to 100:1, more preferably in the range from 10:1 to 50:1, and particularly preferably in the range from 15:1 to 30:1. The step (II) is preferably carried out at a temperature in the range from 150 to 250° C. Comparably high excess of ammonia and comparably low reaction temperatures are important to reduce the formation of side products (e.g. formation of secondary and tertiary amines) and thereby increase the selectivity of the reaction. The reaction is carried out in the presence of hydrogen, preferably with a hydrogen pressure in the range from 100 to 200 bar abs. The reaction of the step (II) is carried out in the presence of a hydrogenation catalyst, preferably a heterogeneous hydrogenation catalyst. Suitable hydrogenation catalysts are based on the metals Co, Ni, Pt, Ru, Rh, Pd or mixtures thereof as active mass. The catalytically active metals can be used in elemental form (such as Raney-Cobalt or Raney-Nickel), or in their oxidized form (as Oxides, Chlorides, Nitrates, such as PtO₂ (Adams Catalyst)) and can be supported on a solid support, e.g., selected from Al₂O₃, ZrO₂, TiO₂, SiO₂, activated carbon and mixtures thereof (such as Ru/C or Co/Al₂O₃). Both, fixed-bed catalysts and suspension catalysts can be used.

During the step (I) of the process for producing the ether-amine composition, dipropylene glycol (reaction product of two propylene oxide units) is formed as part of the polypropylene glycol composition, particularly if a polypropylene glycol composition with a comparably low value of n is prepared. Dipropylene glycol may form undesired side products, e.g., piperazine if present during the amination of the step (II). Accordingly, in a preferred variation of the process for producing the ether-amine composition of the invention, the step (I) is followed by a purification step (I-a) in which dipropylene glycol formed (or employed as initiator) during the step (I) is removed at least partially from the polypropylene glycol composition of the step (I) before the remaining polypropylene glycol composition is employed in the step (II). Preferably this purification step (I-a) is employed within the process for the production of ether-amine having a comparably low value of n or ether-amine composition having a comparably low value of n̅, e.g., in the range from 1 to 3. Preferably this purification step (I-a) is carried out in a way that the residual amount of dipropylene glycol within the polypropylene glycol composition is below 10% b.w., more preferably below 5% b.w., most preferably below 2% b.w. Typically, the purification step (I-a) is carried out by means of distillation, preferably under reduced pressure, e.g., in the range from 10 to 500 mbar abs.

The hydroxyl value of the polypropylene glycol composition resulting from step (I) or (I-a) of the process is preferably in the range from 10 to 1000 mg KOH/g, particularly preferably in the range from 20 to 800 mg KOH/g, very particularly preferably in the range from 40 to 600 mg KOH/g, determined in accordance with DIN 53240-1 (2013). The hydroxyl value is the number of mg of KOH equivalent to the hydroxyl content of 1 g of the alcohol composition. For this determination the sample is first converted with an excess of acetic acid anhydride. The hydroxy groups in the sample react with the acetic acid anhydride, releasing acetic acid. The remaining acetic acid anhydride is then cleaved with water into two molecules of acetic acid. Finally, the total amount of the formed acetic acid is measured by titration with KOH. The hydroxyl value results from the difference between the consumption of KOH (in mg) for the control (without alcohol) and the consumption of KOH for the alcohol composition to be tested (using 1 g of the alcohol composition). Based on the assumption that all compounds of the polypropylene glycol composition are diols (OH-functionality of 2), the average molecular weight M̅_{PPG} correlates directly with the hydroxyl value of the polypropylene glycol composition (HV_{PPG}) according to the following formula:

$${\overline{M}}_{PPG} ( in g / mol ) = 2 * 56 , 000 / {HV}_{PPG}$$

The hydroxyl value of the polypropylene glycol composition and thereby its average molecular weight M̅_{PPG} can be controlled essentially by the choice of the initiator (dipropylene glycol, propylene glycol or water), the ratio of the initiator (dipropylene glycol, propylene glycol or water) to the propylene oxide, and the use of step (I-a). Preferably, propylene glycol or dipropylene glycol is employed as initiator. Preferably, the molar ratio of initiator to propylene oxide is in the range from 1:0.1 to 1:100, particularly preferably in the range from 1:0.5 to 1:50, very particularly preferably in the range from 1:1 to 1:10.

The average molecular weight of the ether-amine composition M_{EA} resulting from step (II) is essentially determined by the average molecular weight of the polypropylene glycol composition M̅_{PPG} which is employed for step (II). Accordingly, the average molecular weight of this ether-amine composition M̅_{EA} can be controlled essentially by controlling the average molecular weight of the polypropylene glycol composition M̅_{PPG}.

The process for producing the ether-amine composition can be performed as a continuous process or as a batch wise process.

Accordingly, the invention further relates to a hardener composition comprising an ether-amine composition obtainable or obtained by the process according to the invention for producing the ether-amine composition.

The hydroxyl value of the ether-amine composition (HV_{EA}) of the invention is preferably in the range from 10 to 1000 mg KOH/g, particularly preferably in the range from 20 to 800 mg KOH/g, very particularly preferably in the range from 40 to 600 mg KOH/g, determined in accordance with DIN 53240-1 (2013). The hydroxy groups in the sample and also the primary and secondary amino groups, react with the acetic acid anhydride used for the determination of the hydroxyl value. Accordingly, if this method is employed for samples having amino groups in addition to hydroxy groups, the hydroxy groups as well as the primary and secondary amino groups contribute equally to the hydroxyl value.

The total amine value (AVₜₒₜₐₗ) of the ether-amine composition of the invention (for the total of primary, secondary and tertiary amines) is preferably in the range from 10 to 1000 mg KOH/g, preferably from 20 to 800 mg KOH/g, particularly preferably from 40 to 600 mg KOH/g. During step (II) of the process for producing the ether-amine composition, primary amines may condensate to secondary amines and further to tertiary amines as side products. Preferably the content of such side products within the ether-amine composition of the invention is low. Accordingly, the amine value for primary amines (AVₚᵣᵢₘ) of the ether-amine composition of the invention is preferably in the range of at least 80%, more preferably in the range of at least 90%, and particularly preferably in the range of at least 95% based on AVₜₒₜₐₗ, and the amine value for secondary amines (AV_{sec}) of the ether-amine composition of the invention is preferably in the range of at most 20%, more preferably in the range of at most 10%, and particularly preferably in the range of at most 5% based on AVₜₒₜₐₗ, and the amine value for tertiary amines (AVₜₑᵣₜ) of the ether-amine composition of the invention is preferably in the range of at most 5%, more preferably in the range of at most 3%, and particularly preferably in the range of at most 1% based on AVₜₒₜₐₗ. The amine values for total, primary, secondary and tertiary amines are determined in accordance with the standard ASTM D2074 (2017).

The degree of amination (D_{A}) achieved by step (II) of the process for producing the ether-amine composition corresponds to the ratio of the number of amino groups to the sum of amino groups and remaining hydroxy groups. Since the number of amino groups is represented by AVₜₒₜₐₗ and the sum of amino and hydroxy groups is represented by HV_{EA} plus AVₜₑᵣₜ (primary and secondary but not tertiary amines contribute to HV_{EA}), D_{A} can be calculated according to the following formula:

$${D}_{A} = {AV}_{t otal} / ( {HV}_{E A} + {AV}_{tert} )$$

This simplified formula for the DA does not take into account the reduction in the number of amine groups due to the formation of secondary (and tertiary) amines.

Preferably, the D_{A} of the ether-amine composition of the invention is in the range of at least 0.80, more preferably in the range of at least 0.90, particular preferably in the range of at least 0.93.

Based on the assumption that all compounds of the ether-amine composition of the invention have two terminal hydroxy and/or primary amino groups, the empirical average molecular weight of such ether-amine composition M̅_{EA,emp} correlates directly with a corrected hydroxyl value (since not only hydroxy and primary amino groups but also secondary amino groups contribute to the hydroxyl value (HV_{EA}), this part (the secondary amine value; AV_{sec}) has to be deducted to consider only the (terminal) hydroxy and primary amino groups) according to the following formula:

$${\overline{M}}_{EA , emp} ( in g / mol ) = 2 * 56 , 000 / ( {HV}_{EA} - {AV}_{sec} )$$

Preferably this empirical average molecular weight of these ether-amines M̅_{EA,emp} is in the range from 180 to 280 g/mol, more preferably in the range from 200 to 260 g/mol or in the range from 320 to 480 g/mol, more preferably in the range from 350 to 450 g/mol, which is in the range of the average molecular weight of the known conventional non-inverse polyetheramines D230 or D400, respectively.

The present invention further relates to a curable composition comprising a resin component comprising at least one epoxy resin and a curing component, characterized in that the curing component is the hardener composition of the invention.

Epoxy resins according to the present invention typically have 2 to 10, preferably 2 to 6, very particularly preferably 2 to 4, and in particular 2, epoxy groups. The epoxy groups are in particular glycidyl ether groups such as are formed in the reaction of alcohol groups with epichlorohydrin. The epoxy resins may be low molecular weight compounds generally having an average molar weight (Mn) of less than 1000 g/mol, or higher molecular weight compounds (polymers). Such polymeric epoxy resins preferably have a degree of oligomerization of 2 to 25, particularly preferably of 2 to 10, units. Said resins may be aliphatic or cycloaliphatic compounds or compounds comprising aromatic groups. In particular, the epoxy resins are compounds comprising two aromatic or aliphatic 6-membered rings or oligomers thereof. Epoxy resins obtainable by reaction of epichlorohydrin with compounds having at least two reactive H atoms, in particular with polyols, are of industrial importance. Epoxy resins obtainable by reaction of epichlorohydrin with compounds comprising at least two, preferably two, hydroxy groups and two aromatic or aliphatic 6-membered rings are of particular importance. Such compounds include in particular bisphenol A and bisphenol F and also hydrogenated bisphenol A and bisphenol F—the corresponding epoxy resins are the diglycidyl ethers of bisphenol A or bisphenol F, or hydrogenated bisphenol A or bisphenol F. Preferably employed as the epoxy resin according to the present invention is an epoxy resin selected from the group consisting of diglycidyl ether of bisphenol A, diglycidyl ether of bisphenol F, diglycidyl ether of hydrogenated bisphenol A and diglycidyl ether of hydrogenated bisphenol F. Typically employed as the epoxy resin according to the present invention is bisphenol A diglycidylether (DGEBA). Suitable epoxy resins according to the present invention also include tetraglycidyl methylenedianiline (TGMDA) and triglycidyl aminophenol or mixtures thereof. Also contemplated are reaction products of epichlorohydrin with other phenols, for example with cresols or phenol-aldehyde adducts, such as phenol-formaldehyde resins, in particular novolacs. Epoxy resins not derived from epichlorohydrin are also suitable. Examples of contemplated resins include epoxy resins comprising epoxy groups due to reaction with glycidyl (meth)acrylate. It is preferable according to the invention to employ epoxy resins or mixtures thereof that are liquid at room temperature. The epoxy equivalent weight (EEW) indicates the average mass of the epoxy resin in g per mole of epoxy group.

It is preferable if the curable composition according to the invention consists to an extent of at least 10% b.w., more preferably at least 30% b.w., particularly at least 50% b.w. of epoxy resin.

The resin component may also comprise one or more reactive diluents. Reactive diluents in the meaning of this invention are compounds which reduce the initial viscosity of the curable composition and which, during the course of the curing of the curable composition, enter into chemical bonding with the network as it forms from epoxy resin and curing agent. For the purposes of this invention, preferred reactive diluents are low-molecular-weight, organic, preferably aliphatic compounds having one or more epoxy groups, and also cyclic carbonates, such as ethylene carbonate, vinylene carbonate or propylene carbonate. Reactive diluents of the invention are preferably selected from the group consisting of1,4-butanediol bisglycidyl ether, 1,6-hexanediol bisglycidyl ether (HDBE), glycidyl neodecanoate, glycidyl versatate, 2-ethylhexyl glycidyl ether, neopentyl glycol diglycidyl ether, p-tert-butyl glycidic ether, butyl glycidic ether, C₃-C₁₀-alkyl glycidyl ether, C₁₂-C₁₄-alkyl glycidyl ether, nonylphenyl glycidic ether, p-tert-butyl phenyl glycidic ether, phenyl glycidic ether, o-cresyl glycidic ether, polyoxypropylene glycol diglycidic ether, trimethylolpropane triglycidic ether (TMP), glycerol triglycidic ether, triglycidyl-para-aminophenol (TGPAP), divinylbenzyl dioxide and dicyclopentadiene diepoxide. They are particularly preferably selected from the group consisting of 1,4-butanediol bisglycidyl ether, 1,6-hexanediol bisglycidyl ether (HDBE), 2-ethylhexyl glycidyl ether, C₃-C₁₀-alkyl glycidyl ether, C₁₂-C₁₄-alkyl glycidyl ether, neopentyl glycol diglycidyl ether, p-tert-butyl glycidic ether, butyl glycidic ether, nonylphenyl glycidic ether, p-tert-butylphenyl glycidic ether, phenyl glycidic ether, o-cresyl glycidic ether, trimethylolpropane triglycidic ether (TMP), glycerol triglycidic ether, divinylbenzyl dioxide and dicyclopentadiene diepoxide. They are in particular selected from the group consisting of 1,4-butanediol bisglycidyl ether, C₃-C₁₀-alkyl monoglycidyl ether, C₁₂-C₁₄-alkyl monoglycidyl ether, 1,6-hexanediol bisglycidyl ether (HDBE), neopentyl glycol diglycidyl ether, trimethylolpropane triglycidic ether (TMP), glycerol triglycidic ether, and dicyclopentadiene diepoxide.

The reactive diluents according to the invention preferably account for a proportion of up to 30% b.w., particularly preferably up to 25% b.w., in particular up to 20% b.w., based on the resin component (epoxy resin and any employed reactive diluents) of the curable composition. In a particular embodiment the reactive diluents according to the invention account for at least 5% b.w., in particular at least 10% b.w., based on the resin component (epoxy resin and any employed reactive diluents) of the curable composition.

The hardener composition may also comprise one or more further amine curing agents (others than the ether-amine compounds of formula I (i.e., formula Ia, Ib or Ic) in addition to the ether-amine composition of the invention. The ether-amine composition of the invention preferably accounts for at least 50% b.w., particularly preferably at least 80% b.w., very particularly preferably at least 90% b.w., based on the total amount of the amine curing agents (ether-amine composition of the invention and any further amine curing agents other than the ether-amine compounds of formula I) in the curable composition. In a particular embodiment the curable composition comprises no further amine curing agents in addition to the ether-amine composition of the invention. In the context of the present invention an amine curing agent is to be understood as meaning an amine having an NH-functionality of ≥2 (thus for example a primary monoamine has an NH-functionality of 2, a primary diamine has an NH-functionality of 4 and an amine having 3 secondary amino groups has an NH functionality of 3). Such further amine curing agents may be aliphatic, cycloaliphatic, or aromatic amines. Examples of such further amine curing agents are the amines selected from the group consisting of 2,2-dimethyl-1,3-propanediamine, 1,3-pentanediamine (DAMP), 1,5-pentanediamine, 1,5-diamino-2-methylpentane (MPMD), 1,6-hexanediamine, 1,7-heptanediamine, 1,8-octanediamine, 1,9-nonanediamine, 1,10-decanediamine, 1,11-undecanediamine, 1,12-dodecanediamine, 2,5-dimethyl-1,6-hexanediamine, 2,2,4- and 2,4,4-trimethylhexamethylenediamine (TMD), dimethyl dicykan (DMDC), isophoronediamine (IPDA), methylcyclohexyl diamine (MCDA), diethylenetriamine (DETA), triethylenetetramine (TETA), aminoethylpiperazine (AEP), Dimethylaminopropylamine (DMAPA), N′-(3-aminopropyl)-N,N-dimethylpropane-1,3-diamine (DMAPAPA), meta-xylylene diamine (MXDA), styrene modified MXDA (Gaskamine® 240), 1,3-bis(aminomethyl cyclohexane) (1,3-BAC), bis(p-aminocyclohexyl)methane (PACM), methylenedianiline (e.g. 4,4′-methylenedianiline), diaminodiphenylmethane (DDM), diaminodiphenylsulfone (DDS), 2,4-toluenediamine, 2,6-toluenediamine, diethyltoluenediamine (DETDA) (e.g. 2,4-diamino-3,5-diethyltoluene or 2,6-diamino-3,5-diethyltoluene, 1,2-diaminobenzene), 1,3-diaminobenzene, 1,4-diaminobenzene, diaminocyclohexane (e.g. 1,2-diaminocyclohexane (DACH)), 1,8-menthanediamine, diaminodiphenyl oxide, 3,3′,5,5′-tetramethyl-4,4′-diaminobiphenyl and 3,3′-dimethyl-4,4′-diaminodiphenyl, and also aminoplast resins such as, for example, condensation products of aldehydes such as formaldehyde, acetaldehyde, crotonaldehyde or benzaldehyde with melamine, urea or benzoguanamine, and also mixtures thereof. Preferably, such further amine curing agents are the amines selected from the group consisting of 2,2,4- and 2,4,4-trimethylhexamethylenediamine (TMD), dimethyl dicykan (DMDC), isophoronediamine (IPDA), methylcyclohexyl diamine (MCDA), diethylenetriamine (DETA), triethylenetetramine (TETA), aminoethylpiperazine (AEP), meta-xylylene diamine (MXDA), styrene modified MXDA (Gaskamine® 240), 1,3-bis(aminomethyl cyclohexane) (1,3-BAC), bis(p-aminocyclohexyl)methane (PACM), diaminocyclohexane (e.g. 1,2-diaminocyclohexane (DACH)), and mixtures thereof.

In the curable composition of the invention it is preferable to use the epoxy compounds (epoxy resins and any reactive diluents having their respective reactive groups) of the resin component and the amine curing agents of the curing component (ether-amine composition and any further amine curing agents) in an approximately equivalent ratio, preferably from 1:0.8 to 1:1.2, based on the epoxy equivalent weight (EEW) of the epoxy compounds and, respectively, the empirical amine hydrogen equivalent weight (AHEWₑₘₚ) of the amine curing agents.

The curable composition according to the invention may also comprise one or more further additions such as for example inert diluents, curing accelerators, reinforcing fibres (in particular glass or carbon fibres), pigments, colorants, fillers, release agents, tougheners, flow agents, antifoams, flame retardants or thickeners. Such additions are typically added in functional amounts, i.e., for example, a pigment is typically added in an amount which results in the composition attaining the desired colour. The compositions according to the invention generally comprise from 0% to 50% b.w., preferably 0% to 20% b.w., for example 2% to 20% b.w. for the entirety of all additives based on the total curable composition. In the context of the present invention additives are to be understood as meaning any additions to the curable composition which are neither epoxy compound nor reactive diluent nor amine curing agent.

The invention further provides a process for producing cured epoxy resins from the curable composition according to the invention. In this process the curable composition according to the invention is provided and subsequently cured. To this end the resin component (including epoxy resin and optionally reactive diluents) and the curing component (comprising the ether-amine composition of the invention) and optionally further components, such as for example inert diluents, curing accelerators, reinforcing fibres, pigments, colorants, fillers, release agents, tougheners, flow agents, antifoams, flame retardants, thickeners or other additives, are contacted with one another, mixed and subsequently cured at a temperature practicable for the application. The curing is preferably carried be carried out at standard pressure and at temperatures of at least 0° C., particularly preferably of at least 10° C., and at temperatures of less than 250° C., particularly preferably of less than 185° C., very particularly preferably of less than 150° C., in particular at a temperature in the range from 0° C. to 185° C., more preferably at a temperature in the range from 10° C. to 150° C., very particularly preferably at a temperature in the range from 10° C. to 75° C., in particular at a temperature in the range from 10° C. to 35° C.

The invention further relates to the cured epoxy resin made of the curable composition according to the invention. The invention especially provides cured epoxy resin obtainable/obtained by curing of a curable composition according to the invention. The invention especially provides cured epoxy resin obtainable/obtained by the process according to the invention for producing cured epoxy resins.

The invention especially provides a process for producing coatings, in particular floor coatings, wherein the curable composition according to the invention is provided, applied to a surface and subsequently cured. To this end the components (resin component, curing component (comprising the ether-amine composition of the invention) and optionally further components such as for example inert diluents, curing accelerators, reinforcing fibres, pigments, colorants, fillers, release agents, tougheners, flow agents, antifoams, flame retardants, thickeners or other additives) are contacted with one another, mixed, applied to a surface and subsequently cured at a temperature practicable for the application. The comparably high reactivity of the ether-amine composition of the invention allows for a curing in reasonable time periods even at temperatures below room temperature.

Coating compositions include for example lacquers. The curable compositions according to the invention may in particular be used to obtain scratch-resistant protective lacquers on any desired substrates, for example made of metal, plastic or wood materials. The curable compositions are also suitable as insulating coatings in electronic applications, for example as insulating coating for wires and cables. Their use for producing photoresists may also be mentioned. They are also suitable as repair lacquer, for example also in the repair of pipes without deinstallation of the pipes (cure in place pipe (CIPP) rehabilitation).

In a further particular embodiment, the invention especially provides a process for adhering articles, wherein the curable composition according to the invention is provided and applied to at least one surface of the articles, followed by the attaching of the articles and the subsequent curing of the curable composition. To this end the components (resin component, curing component (comprising the ether-amine composition of the invention) and optionally further components such as for example inert diluents, curing accelerators, reinforcing fibres, pigments, colorants, fillers, release agents, tougheners, flow agents, antifoams, flame retardants, thickeners or other additives) are contacted with one another, mixed, applied to at least one surface of the articles, followed by the attaching of the articles and the subsequent curing of the curable composition at a temperature practicable for the application. The comparably high reactivity of the ether-amine composition of the invention allows for a curing in reasonable time periods even at temperatures below room temperature.

The curable compositions according to the invention are suitable for curing even in the presence of water or atmospheric humidity on account of their early-stage water resistance. The present invention thus also provides a process for producing cured epoxy resins from the curable composition according to the invention, wherein the curing is carried out in the presence of water or atmospheric humidity, in particular of atmospheric humidity, in particular with a relative atmospheric humidity of at least 50%, very particularly with a relative atmospheric humidity of at least 70%.

In the case of curing in the low temperature range (for example 0° C. to 30° C.) the curable compositions according to the invention combine a relatively high Shore D hardness, which is also achieved relatively rapidly, with a relatively short gel time.

Such profile of properties, which combines for example good mechanical properties, good early-stage water resistance and rapid development of high Shore D hardness, makes the curable compositions according to the invention especially suitable for marine coatings or industrial floor coatings (“flooring”).

The present invention further provides for the use of the ether-amine composition of the invention as a curing agent for epoxy resins, in particular as a curing agent for producing epoxy resin-based coatings, in particular industrial floor coatings (“flooring”).

With a view to the high reactivity, but the otherwise similar property profile compared to the known propylene oxide based polyetheramine hardeners such as Jeffamine® D230 or Jeffamine® D400, the ether-amine compositions of the invention are of course a suitable curing agent for all epoxy resin applications for which the skilled person also knows or is considering the use of these known propylene oxide based polyetheramine hardeners.

Accordingly, beside their use for coatings, the curable compositions according to the invention are also suitable as impregnating composition, as an adhesive, for producing moulded articles and composite materials or as casting compositions for embedding, bonding or consolidating moulded articles.

The amine hydrogen equivalent weight (AHEW) can be determined theoretically or empirically as described by B. Burton et al (Huntsman, “Epoxy Formulations using Jeffamine Polyetheramines”, Apr. 27, 2005, p. 8-11). The theoretically calculated AHEW is defined by the quotient from the amine molecular weight by the number of available hydrogens (i.e.: 2 for any primary amine group plus 1 for any secondary amine group of the amine). By the way of example for IPDA, having a molecular weight of 170.3 g/mol and 2 primary amine groups resulting in 4 available amine hydrogens, the calculated AHEW is 170.3/4=42.6 g/eq). The determination of the empirical AHEW bases on the assumption that equivalent amounts of epoxy resin and amine hardener result in cured epoxy resins which are characterized by a maximum heat distortion temperature (HDT) or a maximum glass transition temperature (T_{g}). Accordingly, to access the empirical AHEW, proportions of the amine hardener relative to a fixed quantity of epoxy resin is varied, the blends are cured as completely as possible, and HDT or T_{g} are determined and plotted against the reactant concentration. The empirical AHEW (AHEWₑₘₚ) is defined by the following formula:

$${AHEW}_{emp} = ( {AH}_{max} * {EEW}_{epox} ) / ER$$

with AHₘₐₓ=amount of amine hardener (in grams) at maximum HDT or T_{g}
   EEWₑₚₒₓ=EEW value of the epoxy resin employed for testing
   ER=amount of the epoxy resin employed for testing in grams In connection with this invention, the determination of the AHEWₑₘₚ is based on maximum T_{g} (measured by the means of DSC according to standard ASTM D 3418 (2015)). The empirical AHEW is of particular importance for cases, e.g., mixtures of polymeric amines, where the calculated AHEW is not accessible.

The curable compositions and the hardener compositions of the invention are characterized by comparable low initial viscosity. The initial viscosity of a curable composition can be determined as mixing viscosity in accordance with the standard DIN EN ISO 3219 (1994) immediately after mixing the components of the curable compositions. The mixing viscosity is determined by the means of a shear stress-controlled cone-plate rheometer (e.g., MCR 301, Anton Paar; with a plate and cone diameter of 50 mm, a cone angle of 1° and a gap distance of 0.1 mm). Temperature is a key factor of such measurement because it influences the viscosity and the curing rate of the curable composition. Accordingly, the viscosity needs to be determined at a particular temperature (e.g., room temperature (23° C.)) in order to allow comparisons.

The cured epoxy resins of the invention are characterized by glass transition temperatures which are in the similar range compared to those which are cured with corresponding commonly known propylene oxide based polyetheramines. The glass transition temperature (T_{g}) can be determined by means of a differential scanning calorimeter (DSC), for example in accordance with the standard ASTM D 3418 (2015). A very small amount of specimen (about 10 mg) is heated (e.g., at 20° C./min) in an aluminum crucible, and the heat flux to a reference crucible is measured. This cycle is repeated at least two times. The glass transition temperature can be determined from the heat-flux curve by way of the inflexion point, or by the half-width method, or by the midpoint temperature method.

The pot life can be determined according to the standard DIN 16945 (1989) (“isothermal viscosity change”). It gives an indication of the time span from mixing of the components in which the reaction resin mass is manageable. For this purpose, the increase of viscosity is determined at a specified temperature (e.g., room temperature (23° C.)) by means of a rheometer (e.g., shear stress-controlled plate-plate rheometer (e.g., MCR 301, Anton Paar) with a plate diameter of e.g., 15 mm and a gap distance of e.g., 0.25 mm) with the time until a specified viscosity limit (e.g., 6,000 mPa*s) is reached. The pot life is then the time until this viscosity limit is reached.

The gel time provides, in accordance with DIN 16945 (1989), information about the period between addition of the curing agent to the reaction mixture and the conversion of the reactive resin composition from the liquid state to the gel state. The temperature plays an important part here, and the gel time is therefore always determined for a predetermined temperature. By using dynamic-mechanical methods, in particular oscillatory rheometry (e.g., shear stress-controlled plate-plate rheometer (e.g., MCR 301, Anton Paar) with a plate diameter of e.g., 15 mm and a gap distance of e.g., 0.25 mm), it is possible to study small amounts of specimens. In accordance with the standard ASTM D 4473 EN (2008), the point of intersection of the storage modulus G′ and the loss modulus G″, at which the damping tan 5 has the value 1 is the gel point, and the time taken, from addition of the curing agent to the reaction mixture, to reach the gel point is the gel time. The gel time thus determined can be considered to be a relative measure of the curing rate for structurally related curing agents.

To determine the B-time, which also serves as a measure of the curing speed, a sample (e.g., 0.5 g) of the freshly prepared curable composition is applied to a (e.g., 145° C.) hot plate (e.g., without indentation) in accordance with the standard DIN EN ISO 8987 (2005) and the time until the formation of threads (gel point) or until sudden solidification (curing) is determined.

Shore hardness is a numerical indicator for polymers such as cured epoxy resins which is directly related to the penetration depth of an indenter into a test specimen, and it is therefore a measure of the hardness of the test specimen. It is determined by way of example in accordance with the standard DIN ISO 7619-1 (2010). A distinction is drawn between the Shore A, C, and D methods. The indenter used is a spring-loaded pin made of hardened steel. In the test, the indenter is forced into the test specimen by the force from the spring, and the penetration depth is a measure of Shore hardness. Determination of Shore hardness A and C uses, as indenter, a truncated cone with a tip of diameter 0.79 mm and an insertion angle of 35°, wherein the Shore hardness D test uses, as indenter, a truncated cone with a spherical tip of radius 0.1 mm and an insertion angle of 30°. The Shore hardness values are determined by introducing a scale extending from 0 Shore (penetration depth 2.5 mm) to 100 Shore (penetration depth 0 mm). The scale value 0 here corresponds to the maximum possible impression, where the material offers no resistance to penetration of the indenter. In contrast, the scale value 100 corresponds to very high resistance of the material to penetration, and practically no impression is produced. The temperature plays a decisive part in the determination of Shore hardness, and the measurements must therefore be carried out in accordance with the standard within a restrictive temperature range of 23° C.±2° C. In the case of floor coatings, it is usually assumed that walking on the floor is possible when Shore D hardness is 45 or above.

Early-stage water resistance is the property of a coating to be contactable with water or atmospheric humidity without damage to the coating after only a short time from application. In the case of coatings based on epoxy resins and amine curing agents such damage refers in particular to carbamate formation which is apparent from the formation of white streaks or crusts on the surface of the fresh coating (usually called “blushing” or “blooming”).

In the context of the present invention the term room temperature is to be understood as meaning a temperature of 23° C.

### FIGURES

FIG. 1 shows the result of carbamate formation (white cloudy streaks or crusts on the surface) according to Example 6 for the curing agents D230 (left image) and i-PEA-230 (right image) after 7 days incubation at temperature of 13° C. and 80% relative atmospheric humidity. In both cases only mild formation of carbamate is observed. The i-PEA-230 sample showed a slightly lower sensitivity towards carbamate formation compared to the D230 sample.

### EXAMPLES

### Example 1

Synthesis of Inverse Polyetheramine with Approx. Average Molecular Weight of 400 g/Mol (“i-PEA-400”)

In a first step, 74.85 g of dipropylene glycol (Sigma) and 0.13 g of tris(pentafluorophenyl)borane (TCI Chemicals) were initially charged into a 300 mL stirred vessel at a temperature of 25° C. The vessel was rendered inert three time with nitrogen and heated to a temperature of 100° C. under continuous stirring. The reaction mixture was allowed to dry under vacuum over a period of 1 h. Subsequently, 165 g of propylene oxide were slowly added over a period of 1 h. After an additional reaction period of 2 h, vacuum was applied for additional 20 min and thereafter the temperature was reduced to 50° C. The resulting inverse polypropylene glycol (226 g) was a colourless oil having a viscosity of 107 mPa*s and a hydroxyl value HV_{PPG} of 265 mg KOH/g which corresponds to an average molecular weight M_{PPG} of 423 g/mol. The viscosity was determined according to DIN EN ISO 3219 (1994) at a temperature of 25° C. using a plate-conus rheometer (Viscotester 550 with conus PK 1, 1° and plate diameter of 28 mm, Haake) with a shear rate of 40 s^{31 1}. The hydroxyl value HV_{PPG} was determined in accordance with DIN 53240-1 (2013). This step has been repeated several times and resulting inverse polypropylene glycol has been collected for the use as starting material in the subsequent step.

In a second step, a 3.5 L autoclave was charged with 365 g of the inverse polypropylene glycol, 500 g of THF, and 200 g of Al₂O₃-supported oxidic Ni/Co/Cu-catalyst (3×3 mm tablets in a catalyst cage). The vessel was sealed, and 800 g of liquid ammonia were added. The autoclave was pressurized with hydrogen to a pressure of 40 bar absolute and heated to a temperature of 210° C. At this temperature, the pressure was adjusted with hydrogen to 250 bar absolute and the reaction mixture was stirred for 10 h. The vessel was cooled to room temperature and depressurized. Water and THF were removed from the crude product with a rotary evaporator to obtain inverse polyetheramine (“i-PEA-400”) having a hydroxyl value HV_{EA} of 261 mg KOH/g, a total amine value AVₜₒₜₐₗ of 256 mg KOH/g, an amine value for the secondary amines AV_{sec} of 9.4 mg KOH/g and an amine value for the tertiary amines AVₜₑᵣₜ of 0.2 mg KOH/g, which corresponds to a degree of amination D_{A} of 98.0% and an average molecular weight M̅_{EA,emp} of 414 g/mol. The hydroxyl value was determined in accordance with DIN 53240-1 (2013) and the amine values were determined in accordance with the standard ASTM D 2074 (2017).

### Example 2

Synthesis of Inverse Polyetheramine with Approx. Average Molecular Weight of 230 g/Mol (“i-PEA-230”)

In a first step, 1679 g of dipropylene glycol and 1.25 g of tris(pentafluorophenyl)borane were charged into a 6.3 L stirred vessel at a temperature of 25° C. The vessel was purged three times with nitrogen and heated to a temperature of 100° C. under continuous stirring. After reaction temperature was reached, 824 g of propylene oxide were added over a period of 1.5 h. After an additional reaction period of 2 h, vacuum was applied for 1 h and thereafter the temperature was reduced to 50° C. The resulting inverse polypropylene glycol (2452 g) was a colorless oil having a viscosity of 70 mPa*s and a hydroxyl value HV_{PPG} of 559 mg KOH/g which corresponds to an average molecular weight M̅_{PPG} of 200 g/mol.

In an intermediate step, unreacted dipropylene glycol was removed from the crude inverse polypropylene glycol of the first step by the means of distillation. A flask fitted with a distillation column was charged with the crude inverse polypropylene glycol of the first step comprising unreacted dipropylene glycol and the pressure was adjusted to 25 mbara. The flask was heated to a temperature of 180° C. and dipropylene glycol was distilled off until the residual content of dipropylene glycol in the sump was below 0.3% b.w. The flask was cooled to room temperature and depressurized to obtain purified inverse polypropylenglycol which was essentially free of dipropylene glycol. The purified inverse polypropylene glycol had a hydroxyl value HV_{PPG} of 463 mg KOH/g which corresponds to an average molecular weight M̅_{PPG} of 242 g/mol.

In a final step, the purified inverse polypropylene glycol of the intermediate step was converted into the corresponding inverse polyetheramine by the means of a continuously performed reductive amination. A tubular reactor was filled with 26 mL of Al₂O₃-supported oxidic Ni/Co/Cu-catalyst (3×3 mm tablets). For catalyst activation, the catalyst was heated to 150° C. under a stream of nitrogen at atmospheric pressure. After 3 h, nitrogen was replaced by hydrogen (100 NL/h) and the temperature was raised to 280° C. After 24 h, the temperature was lowered to 100° C. and hydrogen was reduced to 10 NL/h. The reactor was fed with 12 g/h ammonia and the temperature was raised to 200° C. After the reaction temperature was reached, the purified inverse polypropylene glycol of the intermediate step was fed at 5.5 g/h. The product stream was depressurized to atmospheric pressure and collected. Water was removed from the crude product with a rotary evaporator to yield the inverse polyetheramine (“i-PEA-230”) having a hydroxyl value HV_{EA} of 454 mg KOH/g, a total amine value AVₜₒₜₐₗ of 425 mg KOH/g, an amine value for the secondary amines AV_{sec} of 39.8 mg KOH/g and an amine value for the tertiary amines AVₜₑᵣₜ of 0.7 mg KOH/g, which corresponds to a degree of amination D_{A} of 93.5% and an average molecular weight M̅_{EA,emp} of 252 g/mol. The hydroxyl value and the amine values were determined as described for Example 1.

59±1 mol-% of all aminated terminal propylene oxide units within this inverse polyetheramine exhibited the inverse orientation (—CH(CH₃)—CH₂—NH₂) as determined by quantitative analysis of the ¹H-NMR spectrum.

### Example 3

### Preparation of Curable Compositions of Epoxy Resin and Inverse Polyetheramine

The inverse polyetheramines of Example 1 (i-PEA-400) and Example 2 (i-PEA-230) and for comparison the conventional polyetheramines D-400 and D-230 (BASF) were used for curing epoxy resin (bisphenol A diglycidyl ether, Epilox A19-03, Leuna, EEW: 185 g/mol).

The AHEWₑₘₚ of the polyetheramines was determined based on the ratio of polyetheramine to epoxy resin which resulted in the maximum glass transition temperature (T_{g}) as measured by the means of DSC according to standard ASTM D 3418 (2015). To harden the epoxy resin with the polyetheramines, curable compositions were formulated using a 1:1 stoichiometric ratio on the basis of EEW and AHEWₑₘₚ. The AHEWₑₘₚ values and the corresponding amounts of epoxy resin and polyetheramine are summarized in Table 1. The curable compositions were stirred in a propeller mixer at 2000 rpm for 1 min. Immediately following the preparation of the curable composition, differential scanning calorimetry (DSC) and rheological experiments were conducted, and samples for determining the properties of the cured resins were prepared.

DSC (Q2000, TA Instruments) was used to determine the reaction and thermal profile (onset temperature, reaction enthalpy and glass transition temperature of second run (T_{g})) according to ASTM D 3418 (2015) using a heating rate of 20° C./min starting with room temperature. The T_{g} was determined from the heat-flux curve by way of the inflection point. The DSC results are also summarized in Table 1.

The rheological profiles (mixing viscosity and pot life at 23° C., 45° C. and 75° C., as well as the gel time at 23° C., 70° C., 90° C. and 110° C. and (for the i-PEA-230 and D-230 samples) the B-time at 145° C.) were determined using a conventional rheometer (MCR 301, Anton Paar). For the measurement of the pot life and the gel time according to DIN 16945 (1989) a shear stress-controlled plate-plate setting has been applied with a plate diameter of 15 mm and a gap distance of 0.25 mm, using rotational mode (pot life) or under oscillatory forces (gel time). The pot-life was the time at a given temperature needed to attain a viscosity of 6,000 mPa*s. The gel point was defined as the point of intersection of the storage and loss moduli and the gel time was defined as the time taken, from addition of the hardener to the reaction mixture, to reach the gel point. For the measurement of the mixing viscosity in accordance with the standard DIN EN ISO 3219 (1994) a shear stress-controlled cone-plate setting of the rheometer (plate and cone diameter of 50 mm, a cone angle of 1° and a gap distance of 0.1 mm) has been applied. The B-time according to DIN ISO 16916 (2017) and DIN EN ISO 8987 (2005) was defined as the time needed for a sample (0.5 g of freshly prepared curable composition) on a hot plate (145° C.) without indentation to form threads (gel point) or until sudden solidification (curing). The results of these measurements are also summarized in Table 1.

TABLE 1
Thermal and rheological profile of polyetheramine curing tests

| | i-PEA- | D- | i-PEA- | D- |
|---|---|---|---|---|
| | 400 | 400 | 230 | 230 |
| AHEWₑₘₚ | 109 | 107 | 70 | 60 |
| epoxy resin (g) | 100 | 100 | 100 | 100 |
| polyetheramine (g) | 59 | 58 | 38 | 33 |
| onset temperature (° C.) | 78 | 87 | 79 | 83 |
| reaction enthalpy (J/g) | 319 | 278 | 420 | 421 |
| T_{g} (° C.) | 48 | 45 | 79 | 87 |
| mixing viscosity @ 23° C. (mPa*s) | 655 | 590 | 723 | 640 |
| mixing viscosity @ 45° C. (mPa*s) | 140 | 110 | 150 | 116 |
| mixing viscosity @ 75° C. (mPas) | 35 | 33 | 30 | 30 |
| Pot life @ 23° C. (min) | 579 | 962 | 339 | 551 |
| pot life @ 45° C. (min) | 208 | 322 | 129 | 187 |
| pot life @ 75° C. (min) | 48 | 76 | 31 | 42 |
| gel time @ 23° C. (min) | 2220 | 4294 | 1250 | 1881 |
| gel time @ 70° C. (min) | 83 | 148 | 59 | 89 |
| gel time @ 90° C. (min) | 30 | 50 | 20 | 30 |
| gel time @ 110° C. (min) | 12 | 19 | 8 | 12 |
| B-time (gel) @ 145° C. (sec) | | | 120 | 195 |
| B-time (cure) @ 145° C. (sec) | | | 130 | 215 |

### Example 4

Mechanical Properties of the Epoxy Resin Cured with Inverse Polyetheramines

Curable compositions of epoxy resin (bisphenol A diglycidyl ether, Epilox A19-03, Leuna, EEW: 185 g/mol) and the inverse polyetheramines of Example 1 (i-PEA-400) or Example 2 (i-PEA-230) or for comparison the conventional polyetheramines 0-400 or 0-230 (BASF) were prepared as described in Example 3 and subsequently cured at elevated temperature (2 h 60° C., 2 h 80° C., 2 h 100° C.; specimens with 4 mm thickness). The mechanical parameters (tensile modulus (E-t), tensile strength (σ-M), tensile elongation (\acute{ε}-M), flexural modulus (E-f), flexural strength (σ-fM), flexural elongation (\acute{ε}-fM)) were determined according to ISO 527-2 (1993) and ISO 178 (2006). The Charpy test for impact resistance was performed according to ISO 179-2/1eU (1997). The results of these measurements are summarized in Table 2.

TABLE 2
Mechanical properties of epoxy resin cured with polyetheramines

| | Tensile test | | | Flexural test | | | |
|---|---|---|---|---|---|---|---|
| | E-t | σ-M | \acute{ε}-M | E-f | σ-fM | \acute{ε}-fM | Charpy |
| | (MPa) | (MPa) | (%) | (MPa) | (MPa) | (%) | (kJ/m²) |
| i-PEA-400 | 2905 | 49.6 | 2.7 | 3044 | 80.6 | 3.5 | 100.0 |
| D-400 | 3019 | 55.1 | 2.8 | 3168 | 88.7 | 3.7 | 90.7 |
| i-PEA-230 | 2929 | 59.1 | 4.2 | n.d. | n.d. | n.d. | 85.0 |
| D230 | 2938 | 63.0 | 4.6 | n.d. | n.d. | n.d. | 84.3 |

(n.d.: not determined)

### Example 5

Shore D Hardness of the Epoxy Resin Cured with Inverse Polyetheramines Curable compositions comprising epoxy resin (bisphenol A diglycidyl ether, Epilox A19-03, Leuna, EEW: 185 g/mol) and the inverse polyetheramine of Example 2 (i-PEA-230) or for comparison the conventional polyetheramine D-230 (BASF) were prepared by mixing the resin, the polyetheramin and benzyl alcohol (BnOH) in the amounts indicated in Table 3. The amount of BnOH was adjusted in a way that for both test compositions the same T_{g} of 55° C. was achieved.

Shore D measurements were conducted by pouring 35 g of the curable composition into a polypropylene pan with an inner diameter of 10 cm. The compositions were cured over a period of 8 days at a temperature of 0° C. (at 65% relative humidity). Over this time (after 1, 2, 3, 4 and 7 days) the Shore D hardness of the test specimens (having a thickness of 35 to 36 mm) was determined according to DIN ISO 7619-1 (2010) using a durometer (TI Shore test rig, Sauter Messtechnik). Shore D development is dependent on two factors, the rate of network density build-up and the polymeric backbone stiffness. Here diamines with similar backbone rigidity and functionality are compared, so differences in Shore D development are dependent primarily on the reaction rate. The Shore D results are summarized in Table 3.

TABLE 3
Shore D hardness of epoxy resin cured with polyetheramines at 0° C.

| | A19-03 | amine | BnOH | Shore D after storage at 0° C. for | | | | |
|---|---|---|---|---|---|---|---|---|
| | (g) | (g) | (g) | 1 day | 2 days | 3 days | 4 days | 7 days |
| i-PEA-230 | 28 | 10.6 | 2.8 | n.d. | n.d. | n.d. | 16 | 66 |
| D230 | 30 | 9.4 | 3.6 | n.d. | n.d. | n.d. | n.d. | 51 |

n.d.: not determinable

### Example 6

Carbamation of the Epoxy Resin Cured with Inverse Polyetheramines

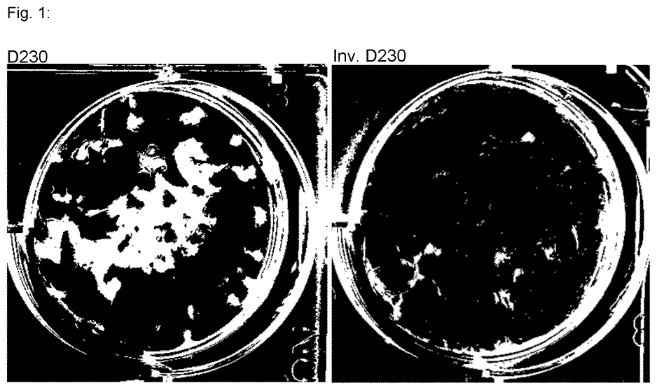

Curable compositions of epoxy resin (bisphenol A diglycidyl ether, Epilox A19-03, Leuna, EEW: 185 g/mol) and the inverse polyetheramine of Example 2 (i-PEA-230) or for comparison the conventional polyetheramine D-230 (BASF) were prepared as described in Example 3. After pouring the curable composition into plastic dishes and subsequently curing at low temperature and high relative humidity (7 days at 13° C., 80% relative humidity; specimens with 4 mm thickness), the carbamate formation on the surface of the specimens was determined by visual inspection. Both samples showed similarly low tendency of carbamate formation, visible as streaks or crusts, however the i-PEA-230 sample showed a slightly lower sensitivity for carbamate formation compared to the D230 sample (FIG. 1).

1. A hardener composition, comprising:
an ether-amine composition consisting of one or more ether-amines of formula I 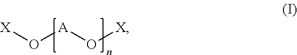
wherein
A=—CH(CH₃)—CH₂— or —CH₂—CH(CH₃)—, and
X (each independently)=—CH(CH₃)—CH₂—NH₂ or —CH₂—CH(CH₃)—N—H₂, and
n≥0,
wherein at least 30 mol-% of all X within the ether-amine composition are —CH(CH₃)—CH₂—NH₂.

2. The hardener composition according to claim 1, wherein at least 40 mol-% of all X within the ether-amine composition are —CH(CH₃)—CH₂—NH₂.

3. The hardener composition according to claim 1, wherein n≥1.

4. The hardener composition according to claim 1, wherein a total amine value of the ether-amine composition is in a range from 10 to 1000 mg KOH/g.

5. The hardener composition according to claim 4, wherein an amine value for primary amines of the ether-amine composition is in a range of at least 80% based on the total amine value.

6. A process for producing a composition according to claim 1, comprising:
preparing, (I), a corresponding polypropylene glycol composition, having the same formula as the ether-amines of the ether-amine composition but with hydroxy groups instead of amino groups, by ring-opening polymerization of propylene oxide using water, propylene glycol or dipropylene glycol as initiator and using an aprotic Lewis acid as catalyst, and
converting, in (II), the polypropylene glycol composition of (I) into a corresponding polyetheramine composition by catalytic reductive amination with hydrogen and ammonia.

7. The process according to claim 6, wherein the aprotic Lewis acid is selected from the group of compounds consisting of triphenylborane, diphenyl-t-butylborane, tri(t-butyl)borane, triphenylaluminum, diphenyl-t-butylaluminum, tri(t-butyl)aluminum, tris(pentafluorophenyl)borane, bis(pentafluorophenyl)-t-butylborane, tris(pentafluorophenyl)aluminum, bis(pentafluorophenyl)-t-butylaluminum, bis(pentafluorophenyl)fluoroborane, di(t-butyl)fluoroborane, (pentafluorophenyl)difluoroborane, (t-butyl)difluoroborane, bis(pentafluoro-phenyl)fluoroaluminum, di(t-butyl)fluoroaluminum, (pentafluorophenyl)difluoroaluminum, and (t-butyl)difluoroaluminum.

8. The process according to claim 6, comprising:
carrying out (II) at a temperature in a range from 150 to 250° C.

9. The process according to claim 6, wherein in (II) a molar ratio of ammonia to the hydroxy groups of the polypropylene glycol composition is in a range from 5:1 to 100:1.

10. The process according to claim 6, comprising:
carrying out (II) in the presence of a catalyst comprising Co, Ni, Pt, Ru, Rh, Pd or mixtures thereof as active mass.

11. The process according to claim 6, wherein (I) is followed by a purification (I-a) in which dipropylene glycol formed or employed as initiator during (I) is removed at least partially from the polypropylene glycol composition of (I) before the remaining polypropylene glycol composition is employed in (II).

12. A curable composition, comprising:
a resin component comprising at least one epoxy resin and a curing component, wherein the curing component is the hardener composition according to claim 1.

13. The curable composition according to claim 12, wherein the curing component comprises one or more further amine curing agents being no ether-amine compounds of formula I.

14. The curable composition according to claim 12, wherein the at least one epoxy resin is selected from the group consisting of diglycidyl ether of bisphenol A, diglycidyl ether of bisphenol F, diglycidyl ether of hydrogenated bisphenol A and diglycidyl ether of hydrogenated bisphenol F.

15. The curable composition according to claim 12, wherein the resin component comprises one or more reactive diluents.

16. The curable composition according to claim 12, further comprising:
one or more further additives.

17. A process for producing a cured epoxy resin, the process comprising:
providing and subsequently curing a curable composition according to claim 12.

18. A cured epoxy resin obtained by the process according to claim 17.
